(19) United States
(12) Patent Application Publication
(10) Pub. No.: US 2025/0336195 A1
(43) Pub. Date: Oct. 30, 2025

(54) EFFICIENT DATA CLASSIFICATION METHOD AND APPARATUS BASED ON DICTIONARY CONTRASTIVE LEARNING VIA ADAPTIVE LABEL EMBEDDING

(71) Applicant: SEOUL NATIONAL UNIVERSITY R&DB FOUNDATION, Seoul (KR)

(72) Inventors: Suhwan CHOI, Seoul (KR); Myungjoo KANG, Seoul (KR)

(21) Appl. No.: 18/937,111

(22) Filed: Nov. 5, 2024

(30) Foreign Application Priority Data
Apr. 25, 2024 (KR) 10-2024-0055583

(51) Int. Cl. G06V 10/82; G06V 10/75; G06V 10/77

(52) U.S. Cl. CPC G06V 10/82; G06V 10/751; G06V 10/7715

(57) ABSTRACT

Proposed are a data classification method and apparatus. The data classification method that is performed by the data classification apparatus includes extracting features from input data through a learning network model and outputting prediction results based on the features, and the learning network model compares local features derived through an individual layer other than the final layer of the learning network model with label embedding vectors corresponding to a classification label.

### CROSS-REFERENCE TO RELATED APPLICATION

This application claims the benefit of Korean Patent Application No. 10-2024-0055583 filed on Apr. 25, 2024, which is hereby incorporated by reference herein in its entirety.

### BACKGROUND

### 1. Technical Field

The embodiments disclosed herein relate to a method and apparatus for classifying input data using a learning network model based on dictionary contrastive learning, and more specifically, to a method and apparatus that extract features from each layer of a learning network model to derive local features and train a learning network model using label embeddings and a contrastive loss function corresponding to each classification label.

The embodiments disclosed herein were derived as a result of the research on the task “Artificial Intelligence Graduate School Program (Seoul National University)” (task management number: IITP-2021-0-01343) of the Information, Communications and Broadcasting Innovative Talent Nurturing Project that was sponsored by the Korean Ministry of Science and ICT and the Institute of Information & Communications Technology Planning & Evaluation.

### 2. Description of the Related Art

The basic learning methods of deep learning include a backpropagation (BP) method, a local learning (LL) method, and a forward learning (FL) method.

First, the backpropagation method performs a forward pass across all the layers of a model to update the weights of a network, derives a final error signal from a last layer, and then passes this signal backward to an input layer to adjust the weights. The backpropagation method requires the symmetry of weights that are used in forward and backward passes. The backpropagation method does not start the backward pass until the forward pass is completely finished, and vice versa. This has the problems of limiting computational efficiency and making parallel processing difficult. Furthermore, the calculation of the gradient of the weights requires storing the local activation of each layer, which is inefficient in terms of memory usage.

Second, the local learning method utilizes a module-wise auxiliary network in a learning network model in order to alleviate the limitations of the backpropagation method. The auxiliary network converts the local features extracted from each module into ones suitable for the calculation of a local loss function and also performs the function of reducing unnecessary information. However, when the auxiliary network is applied, the number of parameters of the model increases significantly and memory consumption increases compared to the forward learning method.

Third, the forward learning method is a method that learns the parameters of each layer via gradient descent through the local error signals of each layer without backpropagation. Since the forward learning method does not use an auxiliary network, the main challenge thereof is to transform local features into ones suitable for the calculation of a loss function. The forward learning method provides lower performance than the backpropagation method or the local learning method due to the absence of an auxiliary network. Although the forward learning method has the potential to significantly improve computational efficiency, it is necessary to secure the effective transformation of local features and the accuracy of learning.

Therefore, there is a demand for a model learning method that has the advantages of the forward and local learning methods while overcoming the limitations of the backpropagation method.

For reference, Patent Document 1 discloses an invention regarding a method and apparatus for generating a synthetic noise image, Patent Document 2 discloses an invention regarding an artificial neural network model training method and system, and Patent Document 3 discloses an invention regarding an artificial neural network training method and an electronic device supporting the same. Patent Documents 1 to 3 only disclose general contents for training an artificial neural network, and do not provide a network model training technology that combines the advantages of forward learning and local learning.

### RELATED ART LITERATURE

### Patent Literature

Patent Document 1: Korean Patent Application Publication No. 10-2023-0151863 (published on Nov. 2, 2023)
Patent Document 2: Korean Patent No. 10-2505946 (published on Mar. 8, 2023)
Patent Document 3: Korean Patent Application Publication No. 10-2022-0049759 (published on Apr. 22, 2022)

### Non-Patent Literature

Non-Patent Document 1: The paper by Priyank Pathak, et al. on “Local Learning on Transformers via Feature Reconstruction.” December 29, 2022.
Non-Patent Document 2: The paper by Yulin Wang, et al. on “Revisiting Locally Supervised Learning: an Alternative to End-to-end Training.” January 26, 2021.
Non-Patent Document 3: The paper by Arild Nøkland, et al. on “Training Neural Networks with Local Error Signals,” May 7, 2019.

### SUMMARY

An object of the embodiments disclosed herein is to achieve learning performance equivalent to or better than that of backpropagation while significantly reducing memory consumption by training a network model based on dictionary contrastive learning using adaptive label embedding.

Other objects and advantages of the present invention may be understood from the following description, and will be more clearly understood from embodiments. In addition, it will be readily understood that the objects and advantages of the present invention may be realized by the means described in the attached claims and combinations thereof.

According to an aspect of the present invention, there is provided a data classification method, the data classification method being performed by a data classification apparatus, the data classification method including extracting features from input data through a learning network model and outputting prediction results based on the features; wherein the learning network model compares local features derived through an individual layer other than the final layer of the learning network model with label embedding vectors corresponding to a classification label.

According to another aspect of the present invention, there is provided a data classification apparatus, including: memory configured to store a learning network model having a plurality of layers; and a controller configured to extract features from input data through the learning network model and output prediction results based on the features; wherein the learning network model compares local features derived through an individual layer other than the final layer of the learning network model with label embedding vectors corresponding to a classification label.

According to still another aspect of the present invention, there is provided a non-transitory computer-readable storage medium having stored thereon a program that, when executed by a processor, causes the processor to execute a data classification method, wherein the data classification method including extracting features from input data through a learning network model and outputting prediction results based on the features, and wherein the learning network model compares local features derived through an individual layer other than the final layer of the learning network model with label embedding vectors corresponding to a classification label.

According to still another aspect of the present invention, there is provided a computer program that is executed by a data classification apparatus and stored in a non-transitory computer-readable storage medium to perform a data classification method, wherein the data classification method including extracting features from input data through a learning network model and outputting prediction results based on the features, and wherein the learning network model compares local features derived through an individual layer other than the final layer of the learning network model with label embedding vectors corresponding to a classification label.

According to some of the above-described solutions, there are proposed the data classification method and apparatus that train a network model based on dictionary contrastive learning while directly comparing local features derived from an individual layer with adaptive label embedding vectors, thereby improving classification performance to a level equal to or higher than that of the backpropagation method while minimizing the number of parameters of the model and memory consumption.

The advantages that can be achieved by the embodiments disclosed herein are not limited to the advantages described above, and other advantages not described above will be clearly understood by those having ordinary skill in the art, to which the embodiments disclosed herein pertain, from the foregoing description.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a diagram illustrating the data flow of a backpropagation method;

FIG. 2 is a diagram illustrating the data flow of a local learning method;

FIG. 3 is a diagram illustrating the data flow of a forward learning method;

FIG. 4 is a block diagram illustrating the functional configuration of a data classification apparatus according to an embodiment;

FIG. 5 is a diagram illustrating the data flow of a learning network model processed by a data classification apparatus according to an embodiment;

FIGS. 6 and 7 are flowcharts illustrating the basic operation and learning operation of a data classification method according to an embodiment; and

FIGS. 8 to 13 are diagrams illustrating learning performance simulated according to embodiments.

### DETAILED DESCRIPTION

Various embodiments will be described in detail below with reference to the accompanying drawings. The following embodiments may be modified to various different forms and then practiced. In order to more clearly illustrate features of the embodiments, detailed descriptions of items that are well known to those having ordinary skill in the art to which the following embodiments pertain will be omitted. Furthermore, in the drawings, portions unrelated to descriptions of the embodiments will be omitted.

Throughout the specification, like reference symbols will be assigned to like portions. Throughout the specification, when one component is described as being “connected” to another component, this includes not only a case where the one component is ‘directly connected’ to the other component but also a case where the one component is ‘connected to the other component with a third component arranged therebetween.’ Furthermore, when one portion is described as “including” one component, this does not mean that the portion does not exclude another component but means that the portion may further include another component, unless explicitly described to the contrary.

Embodiments will be described in detail below with reference to the accompanying drawings.

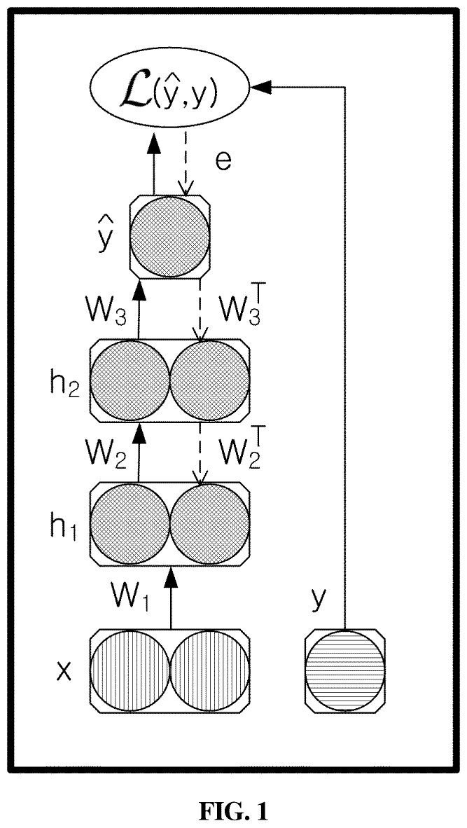

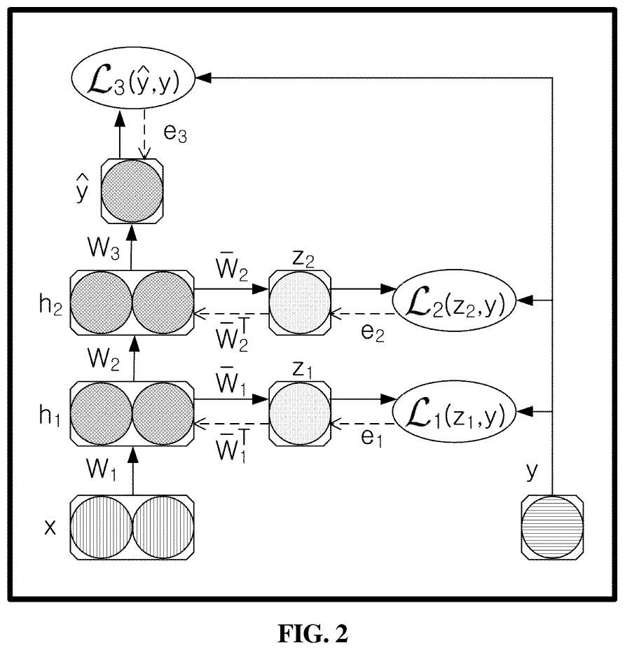

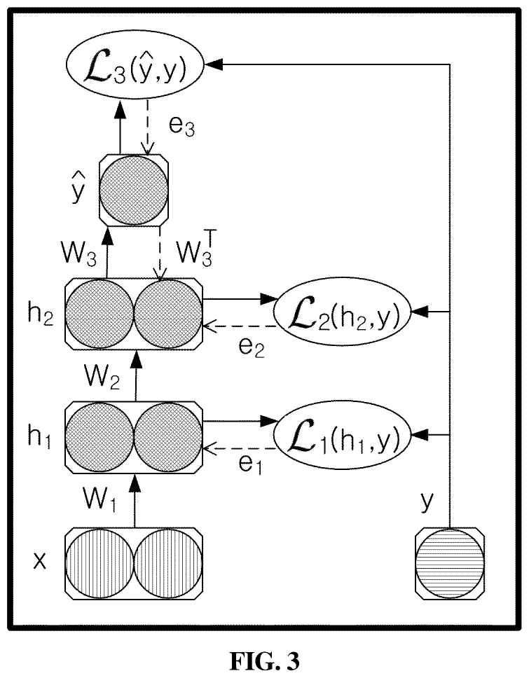

FIG. 1 is a diagram illustrating the data flow of a backpropagation method, FIG. 2 is a diagram illustrating the data flow of a local learning method, and FIG. 3 is a diagram illustrating the data flow of a forward learning method.

In FIGS. 1 to 3, x denotes input data, y denotes a label, ŷ denotes a predicted label which is an inference result, e denotes an error signal, Wᵢ denotes the parameter of the layer of a model, W̅ᵢ denotes the parameter of an auxiliary network, h denotes a local feature, z denotes the output feature of an auxiliary network, and [symbol] denotes a loss function.

The term “network model” is a model that can detect features from input data and classify the input data based on the features. Various types of deep learning network models may be applied according to the need. Among various types of deep learning network models, a convolutional network model is mainly used to process image or video data. A convolutional network model is also called a convolutional neural network (CNN), and may be used as an image feature extraction model, an image identification model, an image classification model, and the like.

The term “features” is the output extracted through a layer of a model, contains information that represents a target well, and is mainly used in the form of vectors. The term “local features” may refer to the features extracted by an individual layer (e.g., an intermediate layer) rather than a final layer. When a layer of a model derives local features, a receptive field or the like may be applied thereto. As features are extracted from a deeper layer, the receptive fields of individual vectors included in the features become larger, so that the vectors can contain information over a wider area.

The term “embedding” is to transform data using latent space so that a model can understand the relationship of data, and the term “embedding vector” is the information represented by a vector through embedding. For example, it can be understood as a form of dimension reduction or data compression. The term “latent space” is a distribution space of features that represents a target well, and is also called “embedding space.”

A network model is formed by a network structure in which a plurality of layers are connected to each other, and each of the layers includes a node, which is a constituent unit. A model may have parameters that are learning targets, and the parameters can include weights and biases.

The term “weight” is a parameter that adjusts the influence of input on output at a node of a layer, and the term “bias” is a parameter that adjusts how easily a node of a layer is activated (output as 1).

The term “activation function” is a function that converts linear values with weights and biases taken into consideration in input into nonlinear values and outputs them. It is also possible to provide a layer that outputs linear values without applying an activation function.

The term “supervised learning” is a method of training a model by using input data that is labeled with labels indicative of correct answers for the data.

The term “label” refers to each class assigned to data, and the term “class” refers to a group to which data belongs in a dataset. The term “correct label” refers to an actual label treated as a correct answer, and the term “predicted label” refers to a label inferred by a model.

The term “error signal” refers to the difference between the predicted value and actual value of a model. An error signal is mainly calculated through a loss function, and may be propagated depending on the connection relationship between layers. Since the operation of a node depends on the output of a previous node, a backpropagation method may be used to overcome the complexity of a gradient operation, which is the rate of change of the error signal.

Referring to FIG. 1, a backpropagation method performs a forward pass across all the layers of a model to update the weights of a network, derives a final error signal from a last layer, and then passes this signal backward to an input layer to adjust the weights. The backpropagation method requires the symmetry of weights used in forward and backward passes. This means that the same weights are used in forward and backward passes. However, this symmetry of weights is considered a biologically implausible factor. In reality, biological neural networks such as the human brain do not use the same path and weights for forward and backward signal passes. Accordingly, the symmetry of weights applied in the backpropagation method makes it difficult to accurately imitate the learning mechanism of the actual brain.

In the backpropagation method, there occur forward locking, where backward propagation can start when forward propagation is completely finished, and backward locking, which is the opposite case. This has the problems of limiting computational efficiency and making parallel processing difficult.

Referring to FIG. 2, a local learning method is a method that utilizes an auxiliary network in a learning network model in order to alleviate the limitations of the backpropagation method. A learning network model is composed of a plurality of modules or layers, in which case a module refers to a unit composed of one or more layers. An auxiliary network converts the local features extracted from each module into ones suitable for the calculation of a local loss function, and also performs the function of reducing unnecessary information. In a local learning method, learning is performed by backpropagating a local error signal on a per-module basis based on a local loss function calculated through an auxiliary network. A local learning method can improve memory efficiency compared to backpropagation learning by performing backpropagation only on a per-module basis.

Referring to FIG. 3, a forward learning method learns the parameters of each layer via gradient descent through the local error signals of each layer without backpropagation. Since the forward learning method does not use an auxiliary network, the main challenge thereof is to transform local features into ones suitable for the calculation of a loss function. The forward learning method provides lower performance than the backpropagation method or the local learning method due to the absence of an auxiliary network. Although the forward learning method has the potential to significantly improve computational efficiency, it is necessary to secure the effective transformation of local features and the accuracy of learning.

The present embodiment is intended to train a model that has the advantages of forward learning and local learning while overcoming the limitations of the backpropagation method, and trains a network model based on dictionary contrastive learning while directly comparing local features derived from an individual layer with adaptive label embedding vectors, thereby improving classification performance to a level equal to or higher than that of the backpropagation method while minimizing the number of parameters of the model and memory consumption.

An algorithm for dictionary contrastive learning-based forward learning according to the present embodiment may be referred to as dictionary contrastive learning (DCL).

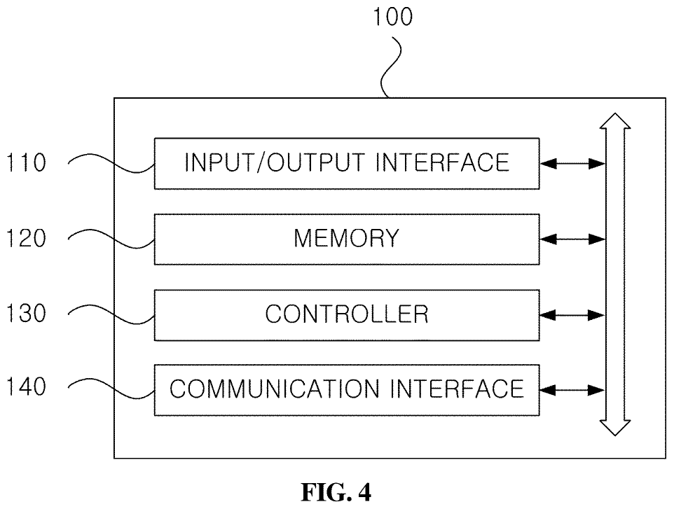

FIG. 4 is a block diagram illustrating the functional configuration of a data classification apparatus according to an embodiment.

Referring to FIG. 4, a data classification apparatus 100 according to an embodiment may include an input/output interface 110, memory 120, a controller 130, and a communication interface 140.

The input/output interface 110 may include an input interface configured to receive input from a user and an output interface configured to display information such as the results of the performance of a task or the status of the data classification apparatus 100. That is, the input/output interface 110 is configured to receive data and output the results of the operation of the data. The data classification apparatus 100 according to an embodiment may receive a request for training or inference, or the like through the input/output interface 110.

The input/output interface 110 may provide a user interface configured to input data to be classified or input a learning network model, and may also provide a user interface configured to output features or labels inferred by the learning network model.

The memory 120 is configured to store files and programs, and may be constructed using various types of memory. In particular, the memory 120 may store data and a program that enable the controller 130, to be described below, to perform operations for model training and data classification according to an algorithm to be presented below.

The memory 120 may store a learning network model having a plurality of layers. The memory 120 may store input data (e.g., an image, a video, and/or the like) input to the learning network. The memory 120 may also store features or prediction results output from the learning network model.

The controller 130 is configured to include at least one processor, such as a central processing unit (CPU), a graphics processing unit (GPU), or the like, and may control the overall operation of the data classification apparatus 100. That is, the controller 130 may control other components included in the data classification apparatus 100 to perform operations for model training and data classification. The controller 130 may perform operations for model training and data classification according to the algorithm to be presented below by executing the program stored in the memory 120.

The communication interface 140 may perform wired/wireless communication with another device or a network. For example, when a specific device that collects or processes input data is implemented as a separate device, the communication interface 140 may receive input data through communication and provide results inferred based on the input data to another device or a user terminal.

To this end, the communication interface 140 may include a communication module configured to support at least one of various wired/wireless communication methods. The communication module may be implemented in the form of a chipset. The mobile or wireless communication supported by the communication interface 140 may be, for example, an N-generation mobile communication protocol, Wireless Fidelity (Wi-Fi), Wi-Fi Direct, Bluetooth, Ultra-Wide Band (UWB), or Near Field Communication (NFC).

The controller 130 may extract features from input data through the learning network model and output prediction results based on the features.

The controller 130 may extract features from each layer of the learning network model. The controller 130 may derive local features through an individual layer other than the final layer of the learning network model, and may compare label embedding vectors corresponding to a classification label with the local features.

The controller 130 may make settings to prevent error signals of local features, derived from at least one layer, from being propagated in the direction of a previous layer by removing the dependency on an operation graph used for gradient calculation so that an operation value processed by the at least one layer of the learning network model cannot be tracked.

The controller 130 may directly or indirectly connect a label embedding dictionary, in which label embedding vectors are mapped, to at least one layer of the network model, and may directly compare the label embedding vectors and the local features using the label embedding dictionary.

The controller 130 may adaptively and dynamically update the label embedding vectors of the label embedding dictionary based on the error signals of the local features.

The controller 130 may form a path so that at least one layer of the learning network model receives the error signals of local features from a loss function set based on dictionary contrastive learning.

The controller 130 may update the parameters of the learning network model through a dictionary contrastive loss function in order to maximize the similarity between label embedding vectors corresponding to the local features in the label embedding dictionary and the local features while minimizing the similarity between label embedding vectors not corresponding to the local features in the label embedding dictionary and the local features.

The controller 130 may calculate a final error signal for the final layer of the learning network model through a final loss function, and may detach a backpropagation path between the immediately previous layer of the final layer and the final layer so that the final error signal is not propagated to the intermediate layer of the learning network model.

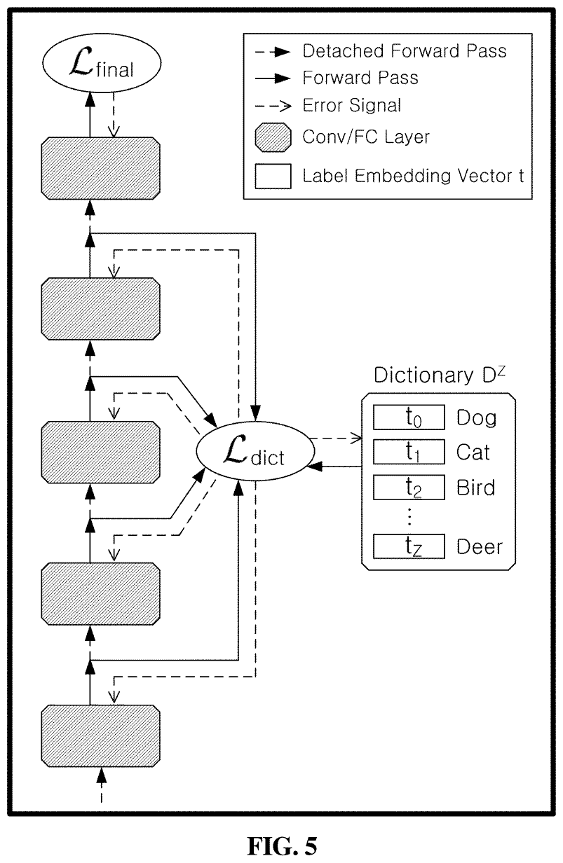

FIG. 5 is a diagram illustrating the data flow of a learning network model processed by a data classification apparatus according to an embodiment.

Contrastive learning is a powerful tool for representation learning, and may be utilized in local learning and forward learning. The local contrastive loss function [symbol] _{contrast} for a batch of local outputs h∈ [symbol] ^{C×H×W} from a forward pass layer used in local learning may be defined as in Equation 1 below:

$${ℒ}_{contrast} = - \frac{1}{{\sum }_{i \neq j} {1}_{{y}_{i} = {y}_{j}}} {\sum }_{i \neq j} [ {1}_{{y}_{i} = {y}_{j}} log \frac{exp ( \frac{{a}_{i}^{T} {a}_{j}}{τ} )}{{\sum }_{k = 1}^{N} {1}_{i \neq k} exp ( \frac{{a}_{i}^{T} {a}_{k}}{τ} )} ] , {a}_{i} = {f}_{ϕ} ( {h}_{i} ) \qquad ( 1 )$$

In this equation, τ is a temperature hyperparameter that adjusts the probability distribution, y∈{1, . . . , Z} is a ground truth label, and f_{ϕ} is an auxiliary network. aᵢ and aⱼ are positive features. The purpose of the local contrastive loss function is to maximize the similarity between positive features while minimizing the similarity between negative features.

The loss function [symbol] _{feat} denotes a local contrastive loss function [symbol] _{contrast} with f_{ϕ}(h)=h.

The auxiliary network applied to local contrastive learning has a great influence on the performance. It is necessary to verify the function of the auxiliary network in order to enhance the performance of the forward learning method that utilizes contrastive learning without auxiliary networks.

The notable disparity in performance between [symbol] _{contrast} using auxiliary networks and [symbol] _{feat} using no auxiliary networks is attributed to the presence of the mutual information I(h,r), where r, referred to as a nuisance, denotes a task-irrelevant variable in x. Then, given a task-relevant variable y, it follows that I(r,y)=0 because mutual information/signifies the amount of information obtained for one random variable by observing another.

[symbol] _{feat} maximizes similarity between local features (h^{+T}h^{P}), rather than similarity between h and labels y. Accordingly, maximizing the similarity between local features could also lead to an increase in I(r⁺, r^{P}), misleading the model to consider task-irrelevant information to be meaningful features.

In this respect, auxiliary networks have the capacity to filter out r, reducing the impact of nuisance r in local learning (LL). However, in forward learning (FL) where auxiliary networks are unavailable, the influence of r becomes more detrimental and noticeable.

In the present embodiment, to address the problem with nuisance r in forward learning (FL), the similarity between local features h and embedding vectors corresponding to target labels may directly be maximized.

In the present embodiment, settings may be made to prevent the layer from propagating an error signal backward by using a command (e.g., detach( ) function) to detach all inputs before the starting of forward pass. That is, the input of the layer or the operation value of the layer is detached from the operation graph so that the error signal is not propagated backward. The final layer may form a path so that it receives the error signal from the final loss function (e.g., cross entropy or the like) for final linear classification, and other layers other than the final layer receive the error signal from the dictionary contrastive loss function. The dictionary contrastive loss function optimizes the similarity between the local features of each layer and the label embedding vectors.

In the present embodiment, labels may be mapped to embedding vectors.

To obtain label embedding t_{z} from each target label y_{z}, an embedding mapping function fₘ may be defined. The embedding mapping function fₘ: [symbol] → [symbol] ^{C}^{_{D}} is a one-to-one mapping from a label to a C_{D}-dimensional label embedding vector, which may be directly compared with dense local features. Every label embedding vector t is initialized as the standard normal random vector, each element of which is a random variable sampled from the standard normal distribution. For Z label classes, a label embedding dictionary may be defined as D^{z}={fₘ(y_{z})|y₂∈{1, . . . , Z}}, where fₘ(y_{z})=t_{z}∈ [symbol] ^{C}^{_{D}}.

In the present embodiment, label embedding vectors may be initialized by two methods.

According to a first initialization method, Z embedding vectors may be initialized orthogonally to each other. The label embedding dictionary D^{⊥} may include orthogonal vectors.

According to a second initialization method, each element of an embedding vector may be initialized by sampling from a standard normal distribution. The label embedding dictionary D^{N} may include standard normal random vectors.

After initialization, the scale of the embedding vector may be adjusted by matching an embedding vector norm.

The present embodiment may adaptively update the label embeddings.

The label embeddings of the label embedding dictionary are based on a dynamic concept in which the label embeddings are updated at each iteration step. DCL, which is a default method, updates label embeddings according to the forward pass of each intermediate layer. Using the DCL method, the label embeddings may be updated through the layer-wise gradients averaged across all intermediate layers. However, the averaging operation that simultaneously integrates the error signals of all layers may have a negative impact on the weight update.

In the present embodiment, two versions of update methods that are more suitable for parallel training may be applied. DCL-O is a method that updates label embeddings by using only error signals from a last intermediate layer. In contrast, DCL-LD is a method that employs a layer-wise dictionary

$${D}_{l}^{Z} = \{ {t}_{z} \vert {t}_{z} ∈ {ℝ}^{{C}_{D}^{l}} , z ∈ \{ 1 , … , Z \} \} .$$

Applying DCL-LD enables the parallel updates of the layer-wise label embeddings.

In the present embodiment, the similarity between label embedding vectors and local features may be optimized.

In the process of optimizing the similarity between the label embedding vectors t and the local features h, the shapes of local features may vary across different architectures, so that the representations of the local features h are standardized. In a model {f₁: 1≤l≤L} having L layers, the local features at the l-th layer are represented as hₗ

$$∈ {ℝ}^{{C}_{h}^{l} \times {K}_{l}} ,$$

where Kₗ is the number of

$${C}_{h}^{l}$$

dimensional feature vectors.

Since

$${C}_{h}^{l}$$

may differ for each layer l, the label embedding vector dimension C_{D} may be defined as

$$max {C}_{h}^{l} .$$

### For DCL,

$${C}_{D} = {max}_{l} {C}_{h}^{l}$$

may be set, and for DCL-LD,

$${C}_{D}^{l} = {C}_{h}^{l}$$

may be set.

For fully connected layers (FC), a flat output vector h_{flat}

$$∈ {ℝ}^{{C}_{h}^{l} \times {K}_{l}}$$

is reshaped into hₗ

$$∈ {ℝ}^{{C}_{h}^{l} \times {K}_{l}} .$$

For convolutional layers, local outputs are feature maps hₗ

$$∈ {ℝ}^{{C}_{h}^{l} \times {H}_{l} \times {W}_{l}} ,$$

where

$${C}_{h}^{l}$$

signifies the channel dimension, whereas Hₗ and Wₗ denote the height and width of the feature maps, respectively. By setting Kₗ=HₗWₗ, the local features may be reconfigured as hₗ

$$∈ {ℝ}^{{C}_{h}^{l} \times {K}_{l}} ,$$

and the integrity of the

$${C}_{h}^{l}$$

-dimensional vectors within the feature maps is maintained.

To prevent backpropagation across layers, the stop gradient operator sg[·] that prevents the gradient from passing through a specific portion of the function may be employed, such that hₗ=fₗ(sg[hₗ₋₁]).

In the present embodiment, learning may be performed using a dictionary contrastive loss function.

The weights of a final prediction layer f_{L} may be updated using a final loss function. For example, a cross-entropy loss function used in backpropagation learning in an existing classification task may be applied as the final loss function.

The weights of other layers {f₁: 1≤l≤L−1} other than the final prediction layer may be updated using the dictionary contrastive loss [symbol] _{dict}. The loss function may be minimized for the local feature batch

$${\{ {h}_{n} \}}_{n = 1}^{N} .$$

The dictionary contrastive loss [symbol] _{dict} may be represented as in Equation 2 below:

$${ℒ}_{dict} = - \frac{1}{N} {\sum }_{n = 1}^{N} [ log \frac{exp ( 〈 {\overline{h}}_{n} , {t}_{+}^{′} 〉 )}{{\sum }_{z = 1}^{Z} exp ( 〈 {\overline{h}}_{n} , {t}_{z}^{′} 〉 )} ] , {t}^{′} ∈ \{ {pool}_{l} ( {t}_{z} ) \vert {t}_{z} ∈ {D}^{Z} \} \qquad ( 2 )$$

where

$${\overline{h}}_{n} : = \frac{1}{K} {\sum }_{k = 1}^{K} {h}_{n}^{K} , 〈 \cdot , \cdot 〉$$

denotes the dot product, and the label embedding vector t₊ corresponds to the label of hₙ.

The dimension of local feature vectors may vary across different layers l. Accordingly, to align the vector dimension of t_{z}∈ [symbol] ^{C}^{_{D}} to that of h̅

$$∈ {ℝ}^{{C}_{h}^{l}} ,$$

the one-dimensional average pooling poolₗ:

$${ℝ}^{{C}_{D}} \to {ℝ}^{{C}_{h}^{l}}$$

is employed differently for each layer l.

In contrast, in the case of DCL-LD, pooling is unnecessary because the layer-wise label embedding t_{z}

$$∈ {D}_{l}^{Z}$$

is initialized to ensure

$${C}_{D}^{l} = {C}_{h}^{l} .$$

The label embedding vector t is of an adaptive type, which updates the weights through error signals from [symbol] _{dict}.

The efficacy of [symbol] _{dict} depends on the number of classes. A higher number of label classes Z tend to yield more pronounced performance when compared to using static label embedding vectors. Nevertheless, [symbol] _{dict} may still achieve competitive performance even with fewer classes than the existing contrastive loss function.

Minimizing [symbol] _{dict} maximizes the similarity between local features h and their corresponding label embedding vectors t₊ while concurrently minimizing the similarity to non-corresponding label embedding vectors. Leveraging this property of [symbol] _{dict}, D^{Z} may be employed for inference without the final linear classifier f_{L}. Predictions may be generated by selecting the target label with the highest similarity to the feature vectors:

$$\hat{y} = arg {max}_{z} 〈 \overline{h} , {t}_{z}^{′} 〉 , {t}^{′} ∈ \{ {pool}_{l} ( {t}_{z} ) \vert {t}_{z} ∈ {D}^{Z} \qquad ( 3 )$$

Accordingly, prediction is possible at every layer. Furthermore, this allows for a weighted sum of layer-wise predictions to serve as the global prediction. This approach surpasses predictions made solely by f_{L}.

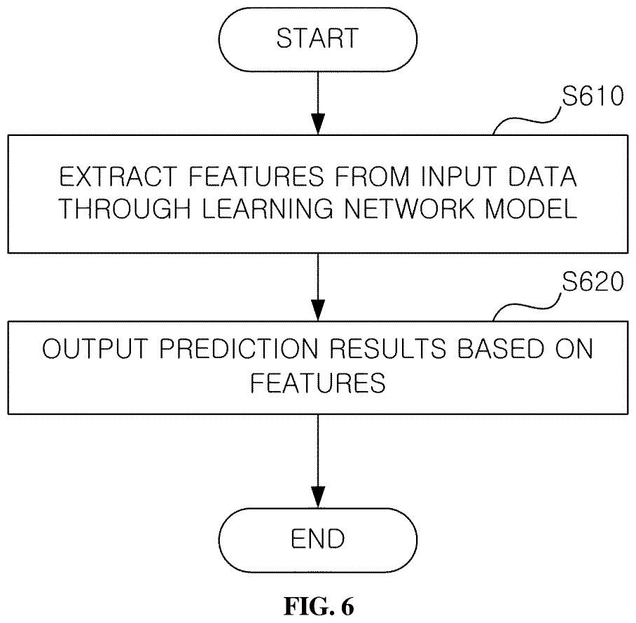

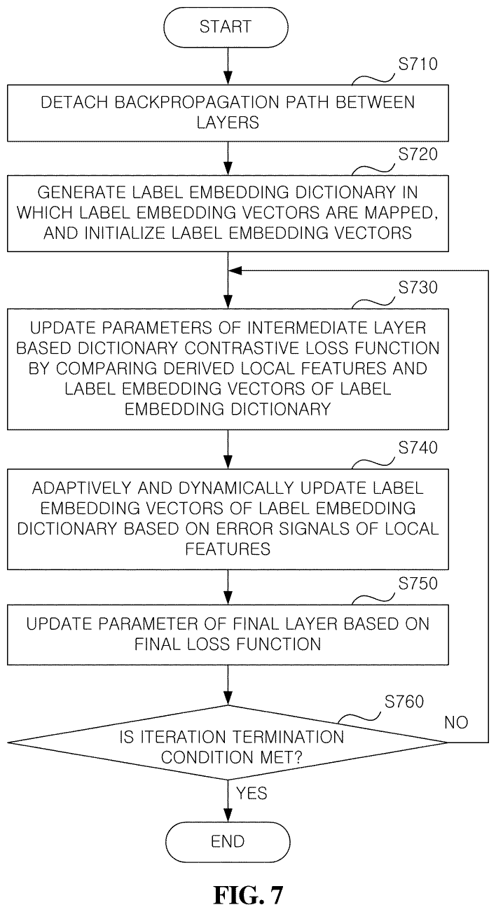

FIGS. 6 and 7 are flowcharts illustrating the basic operation and learning operation of a data classification method according to an embodiment.

The data classification method according to the embodiment shown in FIGS. 6 and 7 includes the steps that are processed in a time-series manner by the data classification apparatus shown in FIGS. 4 and 5. Accordingly, the descriptions that are omitted below but have been given above in conjunction with the data classification apparatus shown in FIGS. 4 and 5 may also be applied to the data classification method according to the embodiment shown in FIGS. 6 and 7.

Referring to FIG. 6, in step S610, the data classification apparatus may extract features from input data through a learning network model. In step S620, the data classification apparatus may output prediction results based on the features. In this case, a model trained according to the sequence of FIG. 7 may be applied as a learning network model.

Referring to FIG. 7, in step S710, the data classification apparatus may detach a backpropagation path between layers. In step S710, the data classification apparatus may remove dependency on an operation graph used for gradient calculation so that an operation value processed by at least one layer of the learning network model cannot be tracked, so that error signals from local features derived from the at least one layer are not propagated in the direction of a previous layer.

In step S720, the data classification apparatus may generate a label embedding dictionary that is directly or indirectly connected to at least one layer of the learning network model. In step S720, the data classification apparatus may map label embedding vectors to the label embedding dictionary. In step S720, the data classification apparatus may initialize the label embedding vectors of the label embedding dictionary.

In step S730, the data classification apparatus may derive local features from an individual layer of the learning network model, and may directly compare label embedding vectors corresponding to a classification label with the local features.

In step S730, in the data classification apparatus, at least one layer of the learning network model may receive the error signals of the local features from a dictionary contrastive loss function [symbol] _{dict}.

In step S730, the data classification apparatus may update the parameters of some layers based on the dictionary contrastive loss function in order to maximize the similarity between label embedding vectors corresponding to the local features in the label embedding dictionary and the local features while minimizing the similarity between label embedding vectors not corresponding to the local features in the label embedding dictionary and the local features. The some layers may be at least one layer, may be the remaining layers excluding a final layer, or may be some intermediate layers.

In step S740, the data classification apparatus may adaptively and dynamically update the label embedding vectors of the label embedding dictionary based on the error signals from the local features.

In step S750, the data classification apparatus may calculate a final error signal for the final layer of the learning network model based on a final loss function [symbol] _{final}, and may update the parameters of the final layer to minimize the final error signal. A backpropagation path between the immediately previous layer of the final layer and the final layer may be detached so that the final error signal is not propagated to the intermediate layer of the learning network model.

In step 760, the data classification apparatus determines whether a repetition termination condition is met. For example, it may be determined whether a condition such as satisfying the number of repetitions or satisfying a reference value for the minimization of a loss function is met.

When the iteration termination condition is not met in step S760, the step of updating the parameters of the model is repeated. For example, steps S730, S740, and S750 may be repeated. When the iteration termination condition is met in step S760, learning may be terminated.

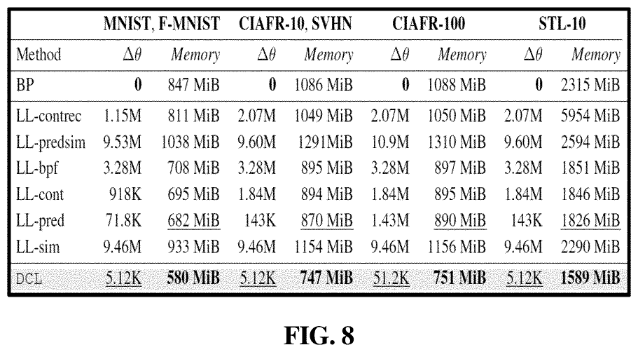

FIGS. 8 to 13 are diagrams illustrating learning performance simulated according to embodiments.

The embodiments (DCL, DCL-O, and DCL-LD) are dictionary contrastive learning-based forward learning algorithms, and comparative examples (LL-cont, LL-contrec, LL-predisim, LL-bpf, LL-pred, and LL-sim) are local learning algorithms. LL-cont is a local learning algorithm using [symbol] _{contrast} of Equation 1, LL-contrec is a local learning algorithm using [symbol] _{contrast} of Equation 1 and the image reconstruction loss function of Non-Patent Document 2, and LL-predisim, LL-bpf, LL-pred, and LL-sim are local learning algorithms using Non-Patent Document 3.

FIG. 8 shows the memory usage and the number of model parameters, and 40 represents the increase in the number of parameters compared to the basic VGG8B model. It can be confirmed that the embodiments were superior in terms of memory usage and model parameters.

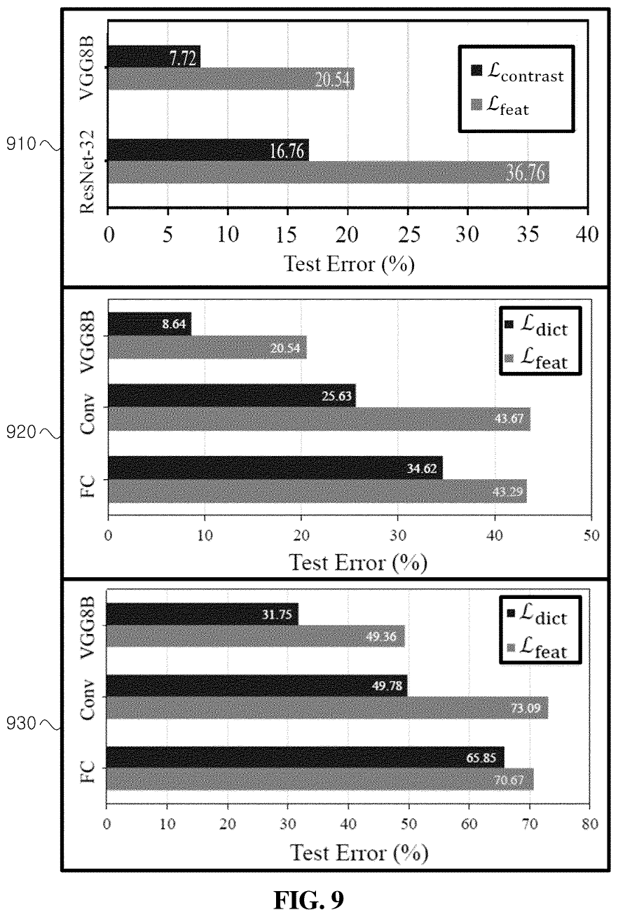

FIG. 9 shows incorrectly predicted test errors. Reference symbol 910 denotes the results of comparison between [symbol] _{contrast} and [symbol] _{feat}, and reference symbols 920 and 930 denote the results of comparison between [symbol] _{dict} and [symbol] _{feat}. It can be confirmed that although the embodiments were forward learning algorithms, performance comparable to that of the local learning was achieved even without using auxiliary networks.

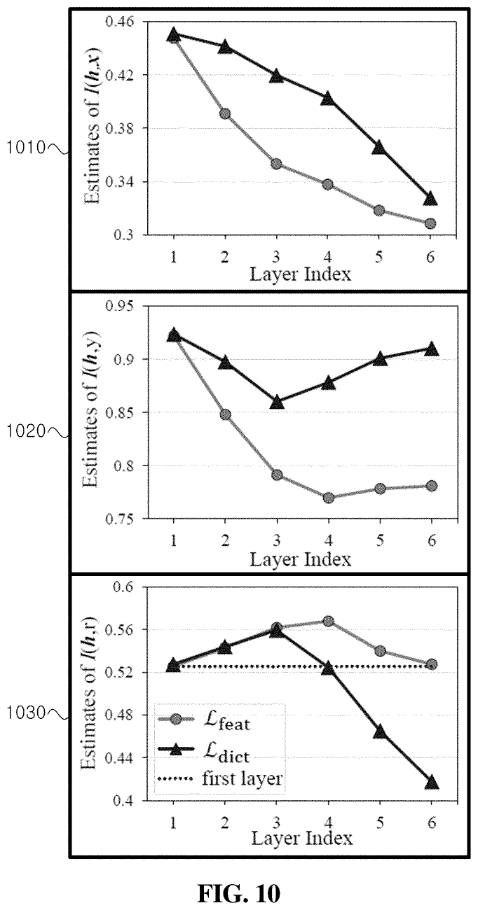

FIG. 10 shows the task-irrelevant information captured by intermediate layers of VGG8B. Reference symbol 1010 denotes estimates of the mutual information between local features h and input images x, reference symbol 1020 denotes estimates of the mutual information between local features h and labels y, and reference symbol 1030 is an estimate of the mutual information between local features h and interference factors r. In particular, it can be confirmed that [symbol] _{dict} effectively reduced the task-irrelevant information as the layer index increased.

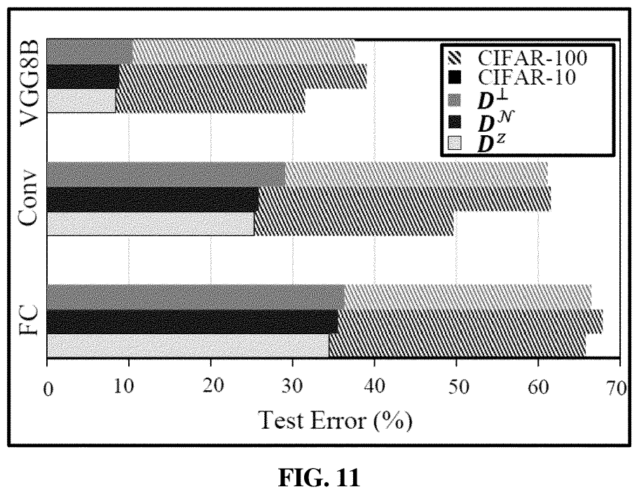

FIG. 11 shows the performance according to the type of label embedding dictionary. It can be confirmed that a dictionary D^{Z} having adaptive embedding vectors had been improved over a dictionary D^{N} having static embedding random vectors and a dictionary D^{⊥} having orthogonal vectors.

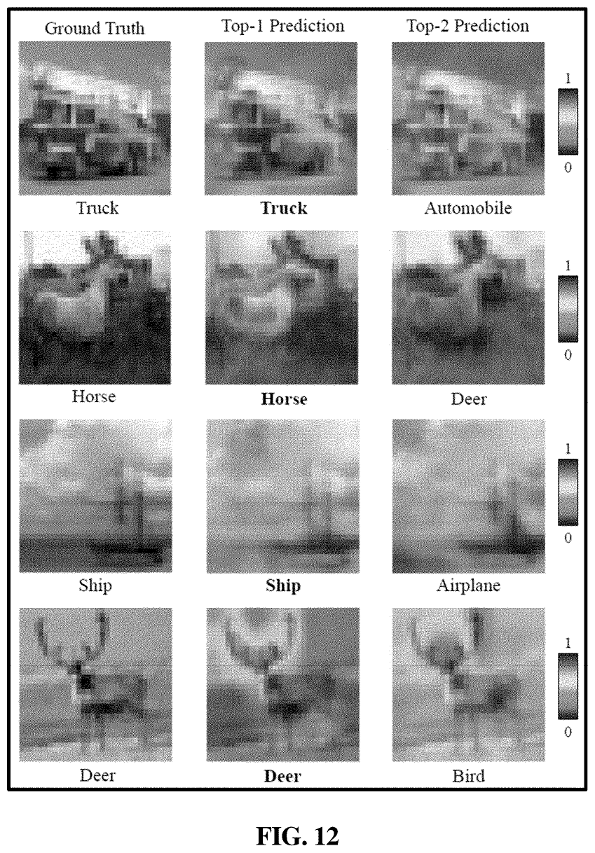

FIG. 12 shows the saliency maps corresponding to the dot product between an embedding vector and an individual local feature vector for one label. It can be confirmed that the results predicted by the embodiments on their top ranking were consistent with correct answers.

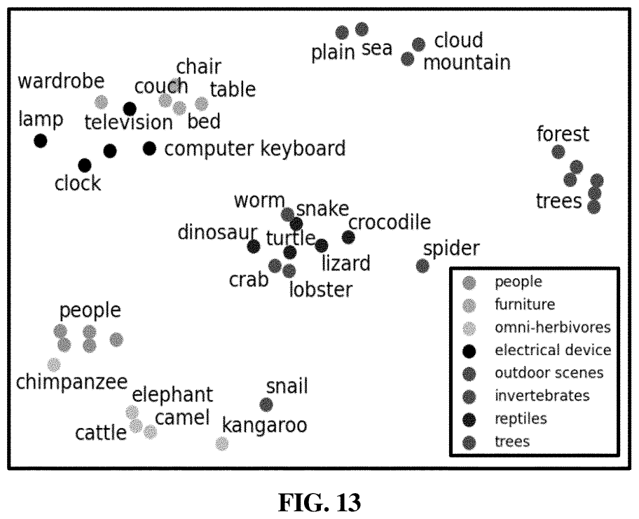

FIG. 13 shows the semantic attributes of adaptive embeddings. It can be confirmed that the embodiments clearly distinguish the semantic relationships of a plurality of super-labels that include a plurality of sub-labels.

The term “unit” used in the above-described embodiments means software or a hardware component such as a field-programmable gate array (FPGA) or application-specific integrated circuit (ASIC), and a “unit” performs a specific role. However, a “unit” is not limited to software or hardware. A “unit” may be configured to be present in an addressable storage medium, and also may be configured to run one or more processors. Accordingly, as an example, a “unit” includes components, such as software components, object-oriented software components, class components and task components, processes, functions, attributes, procedures, subroutines, segments in program code, drivers, firmware, microcode, circuits, data, a database, data structures, tables, arrays, and variables.

Components and a function provided in “unit(s)” may be coupled to a smaller number of components and “unit(s)” or divided into a larger number of components and “unit(s).”

In addition, components and “unit(s)” may be implemented to run one or more central processing units (CPUs) in a device or secure multimedia card.

The data classification method according to an embodiment described through the present specification may be implemented in the form of a computer-readable medium that stores instructions and data that can be executed by a computer. In this case, the instructions and the data may be stored in the form of program code, and may generate a predetermined program module and perform a predetermined operation when executed by a processor. Furthermore, the computer-readable medium may be any type of available medium that can be accessed by a computer, and may include volatile, non-volatile, separable and non-separable media. Furthermore, the computer-readable medium may be a computer storage medium. The computer storage medium may include all volatile, non-volatile, separable and non-separable media that store information, such as computer-readable instructions, a data structure, a program module, or other data, and that are implemented using any method or technology. For example, the computer storage medium may be a magnetic storage medium such as an HDD, an SSD, or the like, an optical storage medium such as a CD, a DVD, a Blu-ray disk or the like, or memory included in a server that can be accessed over a network.

Furthermore, the data classification method according to an embodiment described through the present specification may be implemented as a computer program (or a computer program product) including computer-executable instructions. The computer program includes programmable machine instructions that are processed by a processor, and may be implemented as a high-level programming language, an object-oriented programming language, an assembly language, a machine language, or the like. Furthermore, the computer program may be stored in a tangible computer-readable storage medium (for example, memory, a hard disk, a magnetic/optical medium, a solid-state drive (SSD), or the like).

Accordingly, the data classification method according to an embodiment described through the present specification may be implemented in such a manner that the above-described computer program is executed by a computing apparatus. The computing apparatus may include at least some of a processor, memory, a storage device, a high-speed interface connected to memory and a high-speed expansion port, and a low-speed interface connected to a low-speed bus and a storage device. These individual components are connected using various buses, and may be mounted on a common motherboard or using another appropriate method.

In this case, the processor may process instructions within a computing apparatus. An example of the instructions is instructions which are stored in memory or a storage device in order to display graphic information for providing a Graphic User Interface (GUI) onto an external input/output device, such as a display connected to a high-speed interface. As another embodiment, a plurality of processors and/or a plurality of buses may be appropriately used along with a plurality of pieces of memory. Furthermore, the processor may be implemented as a chipset composed of chips including a plurality of independent analog and/or digital processors.

Furthermore, the memory stores information within the computing device. As an example, the memory may include a volatile memory unit or a set of the volatile memory units. As another example, the memory may include a non-volatile memory unit or a set of the non-volatile memory units. Furthermore, the memory may be another type of computer-readable medium, such as a magnetic or optical disk.

In addition, the storage device may provide a large storage space to the computing device. The storage device may be a computer-readable medium, or may be a configuration including such a computer-readable medium. For example, the storage device may also include devices within a storage area network (SAN) or other elements, and may be a floppy disk device, a hard disk device, an optical disk device, a tape device, flash memory, or a similar semiconductor memory device or array.

The above-described embodiments are intended for illustrative purposes. It will be understood that those having ordinary knowledge in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form.

The scope of protection pursued through the present specification should be defined by the attached claims, rather than the detailed description. All modifications and variations which can be derived from the meanings, scopes and equivalents of the claims should be construed as falling within the scope of the present invention.

What is claimed is:

1. A data classification method, the data classification method being performed by a data classification apparatus, the data classification method comprising extracting features from input data through a learning network model and outputting prediction results based on the features;
wherein the learning network model compares local features derived through an individual layer other than a final layer of the learning network model with label embedding vectors corresponding to a classification label.

2. The data classification method of claim 1, wherein the learning network model is set to prevent error signals of local features, derived from at least one layer, from being propagated in a direction of a previous layer by removing dependency on an operation graph used for gradient calculation so that an operation value processed by at least one layer of the learning network model cannot be tracked.

3. The data classification method of claim 1, wherein the learning network model directly compares the label embedding vectors and the local features by using a label embedding dictionary which is connected to at least one layer of the learning network model and in which the label embedding vectors are mapped.

4. The data classification method of claim 3, wherein the label embedding vectors of the label embedding dictionary are adaptively and dynamically updated based on the error signals of the local features.

5. The data classification method of claim 3, wherein at least one layer of the learning network model receives the error signals of the local features from a loss function set based on dictionary contrastive learning.

6. The data classification method of claim 5, wherein parameters of the learning network model are updated in order to maximize similarity between label embedding vectors corresponding to the local features in the label embedding dictionary and the local features while minimizing similarity between label embedding vectors not corresponding to the local features in the label embedding dictionary and the local features.

7. The data classification method of claim 3, wherein the learning network model is a model which calculates a final error signal for the final layer of the learning network model and in which a backpropagation path between an immediately previous layer of the final layer and the final layer is detached so that the final error signal is not propagated to an intermediate layer of the learning network model.

8. A data classification apparatus, comprising:
memory configured to store a learning network model having a plurality of layers; and
a controller configured to extract features from input data through the learning network model and output prediction results based on the features;
wherein the learning network model compares local features derived through an individual layer other than a final layer of the learning network model with label embedding vectors corresponding to a classification label.

9. A non-transitory computer-readable storage medium having stored thereon a program that, when executed by a processor, causes the processor to execute the method set forth in claim 1.

10. A computer program that is executed by a data classification apparatus and stored in a non-transitory computer-readable storage medium to perform the method set forth in claim 1.
